(19) United States
(12) Patent Application Publication
(10) Pub. No.: US 2023/0308408 A1
(43) Pub. Date: Sep. 28, 2023

(54) TEXT MESSAGING EXTENSION WITHOUT CELLULAR CONNECTIVITY

(71) Applicant: AT&T Intellectual Property I, L.P., Atlanta, GA (US)

(72) Inventors: Howard Lang, Wayside, NJ (US); Joseph Soryal, Glendale, NY (US)

(21) Appl. No.: 17/703,012

(22) Filed: Mar. 24, 2022

(51) Int. Cl. H04L 51/10; H04W 4/14; H04L 51/56

(52) U.S. Cl. CPC H04L 51/10; H04W 4/14; H04L 51/36

(57) ABSTRACT

In one example, a processing system of a mobile communication device may obtain a text message content and an identification of a recipient via a native short message service application of the mobile communication device, embed the text message content in a media file, and transmit the media file via an over-the-top messaging application to a network-based short message service mediation server. In another example, a processing system deployed in a communication network may obtain an over-the-top messaging application message including a media file from a source mobile communication device, where the media file comprises a text message content and an identification of a recipient that are embedded in the media file, extract the text message content and the identification of the recipient from the media file, and transmit the text message content to the recipient via a short messaging service message.

The present disclosure relates generally to text messaging network infrastructure and endpoint device functionality, and more particularly to apparatuses, computer-readable media, and methods for transmitting a media file having an embedded text message content via an over-the-top messaging application to a network-based short message service mediation server for forwarding the text message content to a recipient via a short messaging service message, apparatuses, computer-readable media, and methods for extracting a text message content and an identification of a recipient from a media file received via an over-the-top messaging application message and transmitting the text message content to the recipient via a short messaging service message, and apparatuses, computer-readable media, and methods for extracting a text message content from a media file received via an over-the-top messaging application message and presenting the text message content via a native short messaging service application of a mobile communication device.

### BACKGROUND

Short Message Service (SMS) messaging remains popular both for business (e.g., two-factor authentication, customer updates, etc.) and person-to-person communications. SMS messages may not be delivered if an originating or receiving party is without cellular connection, is roaming internationally, or is in another scenario in which an SMS communication path is disabled, blocked, or otherwise unavailable.

### SUMMARY

In one example, the present disclosure discloses a method, computer-readable medium, and apparatus for transmitting a media file having an embedded text message content via an over-the-top messaging application to a network-based short message service mediation server for forwarding the text message content to a recipient via a short messaging service message. For example, a processing system including at least one processor (e.g., of a mobile communication device) may obtain a text message content and an identification of a recipient via a native short message service application of the mobile communication device, embed the text message content in a media file, and transmit the media file via an over-the-top messaging application to a network-based short message service mediation server, where the network-based short message service mediation server is to extract the text message content from the media file and to forward the text message content to the recipient via a short messaging service message.

In one example, the present disclosure also discloses a method, computer-readable medium, and apparatus for extracting a text message content and an identification of a recipient from a media file received via an over-the-top messaging application message and transmitting the text message content to the recipient via a short messaging service message. For example, a processing system including at least one processor deployed in a communication network may obtain an over-the-top messaging application message including a media file from a source mobile communication device, where the media file comprises a text message content and an identification of a recipient that are embedded in the media file, extract the text message content and the identification of the recipient from the media file, and transmit the text message content to the recipient via a short messaging service message.

In addition, in one example, the present disclosure further discloses a method, computer-readable medium, and apparatus for extracting a text message content from a media file received via an over-the-top messaging application message and presenting the text message content via a native short messaging service application of a mobile communication device. For example, a processing system including at least one processor (e.g., of a mobile communication device) may obtain an over-the-top messaging application message including a media file from a network-based short message service mediation server, where the media file comprises a text message content that is embedded in the media file, extract the text message content from the media file, and present the text message content via a native short messaging service application of the mobile communication device.

### BRIEF DESCRIPTION OF THE DRAWINGS

The teachings of the present disclosure can be readily understood by considering the following detailed description in conjunction with the accompanying drawings, in which:

FIG. 1 illustrates an example system related to the present disclosure;

FIG. 2 illustrates a flowchart of an example method for transmitting a media file having an embedded text message content via an over-the-top messaging application to a network-based short message service mediation server for forwarding the text message content to a recipient via a short messaging service message;

FIG. 3 illustrates a flowchart of an example method for extracting a text message content and an identification of a recipient from a media file received via an over-the-top messaging application message and transmitting the text message content to the recipient via a short messaging service message;

FIG. 4 illustrates a flowchart of an example method for extracting a text message content from a media file received via an over-the-top messaging application message and presenting the text message content via a native short messaging service application of a mobile communication device; and

FIG. 5 illustrates an example high-level block diagram of a computer specifically programmed to perform the steps, functions, blocks, and/or operations described herein.

To facilitate understanding, identical reference numerals have been used, where possible, to designate identical elements that are common to the figures.

### DETAILED DESCRIPTION

The present disclosure broadly discloses apparatuses, computer-readable media, and methods for transmitting a media file having an embedded text message content via an over-the-top messaging application to a network-based short message service mediation server for forwarding the text message content to a recipient via a short messaging service message, apparatuses, computer-readable media, and methods for extracting a text message content and an identification of a recipient from a media file received via an over-the-top messaging application message and transmitting the text message content to the recipient via a short messaging service message, and apparatuses, computer-readable media, and methods for extracting a text message content from a media file received via an over-the-top messaging application message and presenting the text message content via a native short messaging service application of a mobile communication device. In particular, Short Message Service (SMS) messaging primarily uses the cellular network to transmit and receive. Examples of the present disclosure utilize a non-SMS data communication path, such as cellular data, “over-the-top” data communication, and/or non-cellular wireless communications (e.g., IEEE 802.11-based communications (Wi-Fi, or the like)) to convey SMS messages when an SMS cellular communication is not available for either a sender or a recipient. For instance, SMS cellular communication may be unavailable when a mobile device is roaming in a foreign country or when a mobile device is without cellular coverage, such as being in a domestic rural area. For instance, SMS messages are frequently used as part of two-factor authentication (2FA) for many applications. When a subscriber is roaming (e.g., in a foreign country) delivery of SMS messages may not complete, thereby creating challenges to applications that utilize two-factor authentication, e.g., interrupting financial transactions, interrupting authentications, etc. Similarly, when a subscriber has no cellular coverage (and is without network-connectivity, or only has a non-cellular data connection), SMS messages may not complete. Thus, in either case, the subscriber may be prevented from completing a two-factor authentication process.

Examples of the present disclosure convey text message content from a sender or to a recipient embedded in a media file that is sent via an over-the-top (OTT) messaging application message. For instance, in one example, the present disclosure may embed text message content in a digital photograph or video (e.g., in a JPEG file, an MPEG file, or the like), and may convey the text message content embedded in the digital photograph or video at least in part via a voice over internet protocol (VoIP) application communication. To illustrate, in one example, a sending mobile device without a present ability to use a native SMS service (e.g., without cellular coverage, or roaming internationally) may embed the text message content in the digital photograph or video and may send the digital photograph or video to an SMS mediation server via a VoIP call using a VoIP application (app) of the mobile device. For instance, the digital photograph or video may be sent as an attachment within a VoIP call session. The SMS mediation server may then extract the text message content from the digital photograph or video and send the text message content to one or more intended recipients via SMS message(s).

Similarly, in another example, an intended recipient (e.g., a mobile device) may be without a native SMS service (e.g., without cellular coverage, or roaming internationally). In such case, an SMS mediation server may receive an SMS message from a sender device (or from another SMS server, such as a short message service center (SMSC) or the like). The SMS mediation server may then embed the text message content in a digital photograph or video and send the digital photograph or video to the recipient mobile device via a VoIP call. The recipient mobile device may then extract the text message content from the digital photograph or video received via the VoIP application (app) and pass the text message content to a native SMS application of the mobile device as an SMS message (e.g., via an API for local interactions between applications on the same device).

In another example, the present disclosure may embed text message content in an audio file that may be transmitted from a sender mobile device to an SMS mediation server, or from the SMS mediation server to a recipient mobile device. In still another example, the present disclosure may embed text message content into a Portable Document Format (PDF) file, a text document, a holographic image or video file, or other types of media files, and may convey the media file from a sender mobile device to an SMS mediation server, or from the SMS mediation server to a recipient mobile device using an OTT messaging application, such as Skype™, WhatsApp™, Facebook Messenger™, Blackberry Messenger (BBM)™, Facetime™, and so forth.

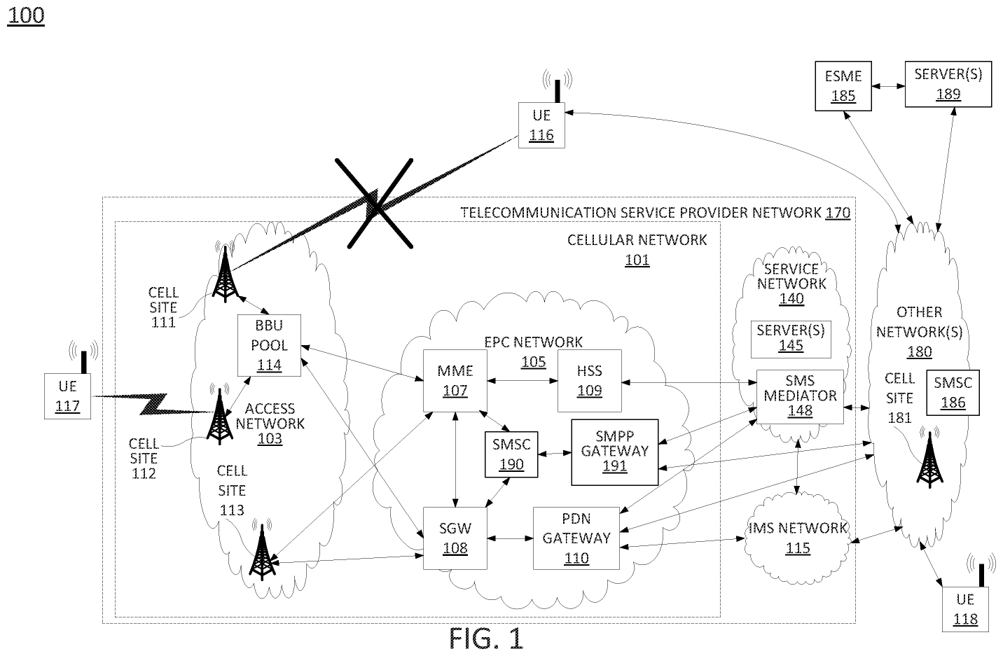

SMS messaging remains popular both for business (e.g., two-factor authentication, customer updates, etc.) and person-to-person communications. SMS messages may not be delivered if an originating or receiving party is without cellular connection, is roaming internationally, or is in another scenario in which an SMS communication path is disabled, blocked, or otherwise unavailable. Examples of the present disclosure provide several alternative pathways to interoperate between devices and users having cellular and non-cellular connectivity through a network-based SMS mediator that leverages alternate transport mechanisms and media file embedding to carry text message content of SMS messages over a data connection. Thus, examples of the present disclosure enable delivery of SMS messages to be completed, where they might otherwise fail. In addition, user may remain more fully connected when roaming and/or in areas with data-only connections (e.g., international travel, using hotel or home Wi-Fi, etc.). These and other aspects of the present disclosure are discussed in greater detail below in connection with the examples of FIGS. 1-5.

To better understand the present disclosure, FIG. 1 illustrates an example system 100 in which examples of the present disclosure may operate. In one example, the system 100 includes a telecommunication service provider network 170. The telecommunication service provider network 170 may comprise a cellular network 101 (e.g., a 4G/Long Term Evolution (LTE) network, a 4G/5G hybrid network or future generation network, or the like), a service network 140, and an IP Multimedia Subsystem (IMS) network 115 (or IMS core network). In one example, the cellular network 101 comprises an access network 103 and a core network, Evolved Packet Core (EPC) network 105. The system 100 may further include other networks 180 connected to the telecommunication service provider network 170. FIG. 1 also illustrates various mobile endpoint devices, e.g., user endpoints, or user equipment (UE) 116-118. The UEs 116-118 may each comprise a cellular telephone, a smartphone, a tablet computing device, a laptop computer, a pair of computing glasses, a wireless enabled wristwatch, or any other cellular-capable mobile telephony and computing devices (broadly, “a mobile communication device”). It should also be noted that each of the UEs 116-118 may also include components for non-cellular wireless or wired network connectivity.

In one example, the access network 103 may comprise a cloud RAN. For instance, a cloud RAN is part of the 3^{rd} Generation Partnership Project (3GPP) 5G specifications for mobile networks. As part of the migration of cellular networks towards 5G, a cloud RAN may be coupled to an EPC network until new cellular core networks are deployed in accordance with 5G specifications. In one example, access network 103 may include cell sites 111 and 112 and a baseband unit (BBU) pool 114. In a cloud RAN, radio frequency (RF) components, referred to as remote radio heads (RRHs), may be deployed remotely from baseband units, e.g., atop cell site masts, buildings, and so forth. In one example, the BBU pool 114 may be located at distances as far as 20-80 kilometers or more away from the antennas/remote radio heads of cell sites 111 and 112 that are serviced by the BBU pool 114. It should also be noted in accordance with efforts to migrate to 5G networks, cell sites may be deployed with new antenna and radio infrastructures such as multiple input multiple output (MIMO) antennas, and millimeter wave antennas.

Although cloud RAN infrastructure may include distributed RRHs and centralized baseband units, a heterogeneous network may include cell sites where RRH and BBU components remain co-located at the cell site. For instance, cell site 113 may include RRH and BBU components. Thus, cell site 113 may comprise a self-contained “base station.” With regard to cell sites 111 and 112, the “base stations” may comprise RRHs at cell sites 111 and 112 coupled with respective baseband units of BBU pool 114. In accordance with the present disclosure, any one or more of cell sites 111-113 may be deployed with antenna and radio infrastructures, including multiple input multiple output (MIMO) and millimeter wave antennas. In one example, any one or more of cell sites 111-113 may comprise one or more directional antennas (e.g., capable of providing a half-power azimuthal beamwidth of 60 degrees or less, 30 degrees or less, 15 degrees or less, etc.). In one example, any one or more of cell sites 111-113 may comprise a 5G “new radio” (NR) base station.

In one example, the EPC network 105 provides various functions that support wireless services in the LTE environment. In one example, EPC network 105 is an Internet Protocol (IP) packet core network that supports both real-time and non-real-time service delivery across a LTE network, e.g., as specified by the 3GPP standards. In one example, cell sites 111 and 112 in the access network 103 are in communication with the EPC network 105 via baseband units in BBU pool 114. In operation, UE 116 may access wireless services via the cell site 111 and UE 117 may access wireless services via the cell site 112 located in the access network 103. It should be noted that any number of cell sites can be deployed in access network. In one illustrative example, the access network 103 may comprise one or more cell sites.

In EPC network 105, network devices such as Mobility Management Entity (MME) 107 and Serving Gateway (SGW) 108 support various functions as part of the cellular network 101. For example, MME 107 is the control node for the LTE access network. In one embodiment, MME 107 is responsible for UE (user equipment) tracking and paging (e.g., such as retransmissions), bearer activation and deactivation process, selection of the SGW, and authentication of a user. In one example, SGW 108 routes and forwards user data packets, while also acting as the mobility anchor for the user plane during inter-cell handovers and as the anchor for mobility between 5G, LTE and other wireless technologies, such as 2G and 3G wireless networks.

In addition, EPC network 105 may comprise a Home Subscriber Server (HSS) 109 that contains subscription-related information (e.g., subscriber profiles), performs authentication and authorization of a wireless service user, and provides information about the subscriber's location. The EPC network 105 may also comprise a packet data network (PDN) gateway 110 which serves as a gateway that provides access between the EPC network 105 and various data networks, e.g., service network 140, IMS core network 115, other network(s) 180, and the like. The packet data network gateway 110 is also referred to as a PDN gateway, a PDN GW or a PGW. The EPC network 105 may include other elements that are omitted from illustration in FIG. 1, such as a Diameter Routing Agent (DRA), which may be engaged in the proper routing of messages between other elements within EPC network 105, and with other components of the system 100, such as a call session control function (CSCF) (not shown) in IMS core network 115. For clarity, not all of the connections between components of EPC network 105 are necessarily illustrated of FIG. 1.

In one example, service network 140 may comprise one or more devices, such as servers 145 (e.g., one or more application servers) for providing services to subscribers, customers, and or users. For example, telecommunication service provider network 170 may provide a cloud storage service, web server hosting, and other services. As such, service network 140 may represent aspects of telecommunication service provider network 170 where infrastructure for supporting such services may be deployed. In addition, it should be understood that service network 140 may include any number of components to support one or more services that may be provided to one or more subscribers, customers, or users by the telecommunication service provider network 170.

In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, one or more other telecommunication service provider networks (which may further comprise cellular access network(s), cellular core network(s), etc.), and the like. In one example, the other networks 180 may include different types of networks. In another example, the other networks 180 may be the same type of network. In one example, the other networks 180 may represent the Internet in general.

In accordance with the present disclosure, any one or more of the components of EPC network 105 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 107 may comprise a vMME, SGW 108 may comprise a vSGW, and so forth. In this regard, the EPC network 105 may be expanded (or contracted) to include more or less components than the state of EPC network 105 that is illustrated in FIG. 1.

In one example, cellular network 101 also includes a short message service center (SMSC) 190. In one example, SMSC 190 is responsible for receiving SMS messages from and forwarding SMS messages to endpoint devices. For example, SMSC 190 may transmit SMS messages to other networks 180, when a SMS message originates from UE 116, UE 117, or another endpoint device connected to access network 103, and may forward SMS messages to UE 116, UE 117, or another endpoint device, when a SMS message is sent from elsewhere to the UE 116, UE 117, or another endpoint device. If, for example, UE 116 is unavailable to receive an SMS message, the SMSC 190 may store the SMS message until UE 116 becomes available. In one example, SMPP gateway 191 may comprise a routing entity (RE) for delivering data via SMPP (Short Message Peer-to-Peer Protocol) between external short message entities (ESMEs) (such as ESME 185) and one or more SMSCs of a cellular network, e.g., over an IP backbone. For instance, SMPP gateway 191 may forward SMS messages received via SMPP from SMS mediator 148 (also referred to herein as an “SMS mediation server”) in service network 140.

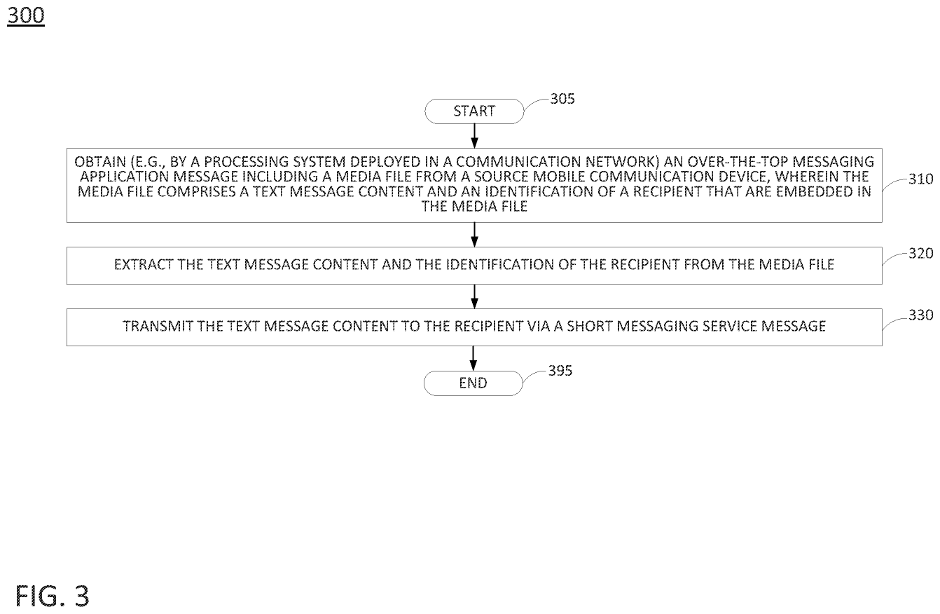

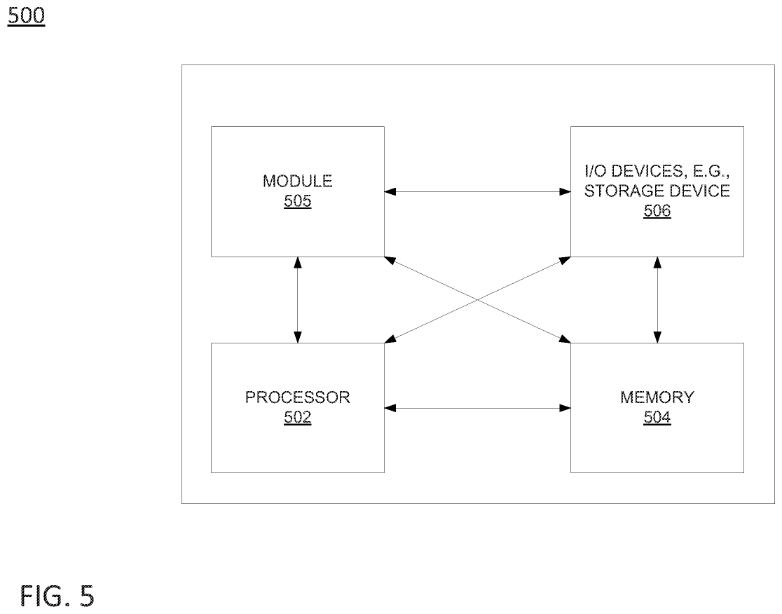

In accordance with the present disclosure, SMS mediator 148 may comprise a computing system or server (e.g., an application server (AS)), or one or more computing systems or servers, such as computing system 500 depicted in FIG. 5, that may individually or collectively be configured to perform operations or functions for extracting a text message content and an identification of a recipient from a media file received via an over-the-top messaging application message and transmitting the text message content to the recipient via a short messaging service message (such as illustrated and described in connection with the example method 300 of FIG. 3). In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below, and which may include central processing units (CPUs), graphics processing units (GPUs), programmable logic devices (PLDs), and so forth) or multiple computing devices collectively configured to perform various steps, functions, and/or operations in accordance with the present disclosure.

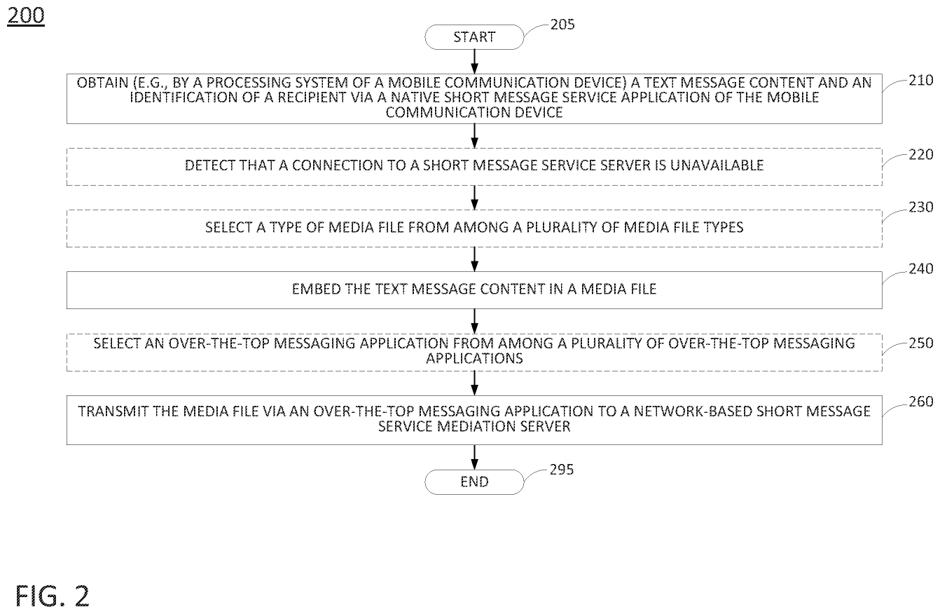

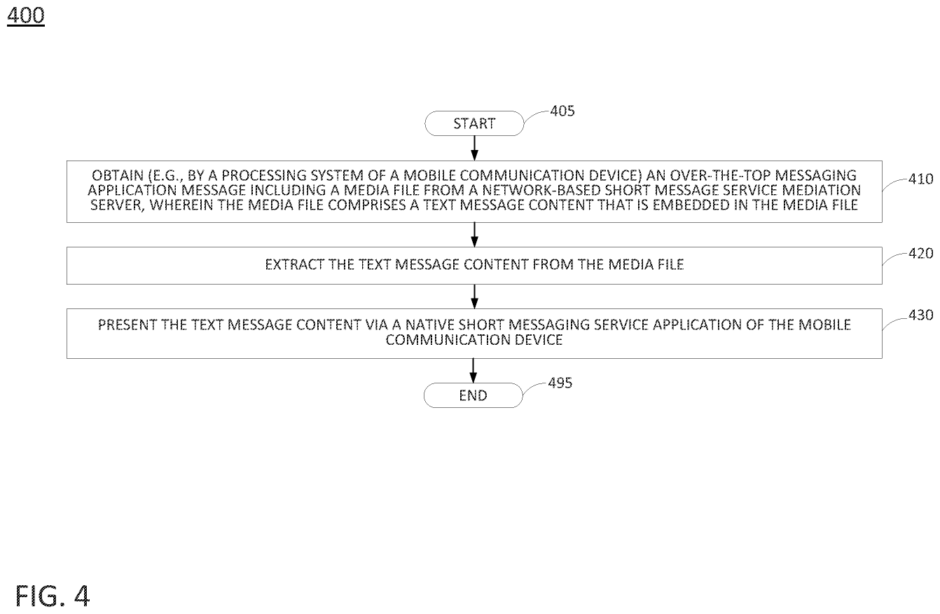

Similarly, it should be noted that each of UEs 116-118 may comprise a computing device or processing system, such as computing system 500 depicted in FIG. 5, that be configured to perform operations or functions for transmitting a media file having an embedded text message content via an over-the-top messaging application to a network-based short message service mediation server for forwarding the text message content to a recipient via a short messaging service message (such as illustrated and described in connection with the example method 200 of FIG. 2) and/or for extracting a text message content from a media file received via an over-the-top messaging application message and presenting the text message content via a native short messaging service application of a mobile communication device (such as illustrated and described in connection with the example method 400 of FIG. 4).

In accordance with the present disclosure, UEs 116-118 (and other UEs associated with subscribers of telecommunication service provider network 170) may be registered with SMS mediator 184 in connection with an alternate/backup SMS delivery service. In one example, a registration may include one or more UE identifiers (e.g., an IMSI, IMEI or the like), and preferences for one or more alternative, over-the-top (OTT) messaging services to use as a delivery mechanism. In one example, the preferences may be user-specified. In another example, an application or service of a UE may access other applications installed on the device to identify available OTT messaging applications, and may select a default ordering (such as arranging by most used, arranging by order of reliability as determined by an operator of the telecommunication service provider network 170, or other criteria).

In an illustrative example, UE 118 may be roaming in a foreign country and may have cellular network connectivity via cell site 181. UE 118 may wish to send an SMS message to UE 117. However, UE 118 may not have access to SMS service via a foreign telecommunication service provider's SMSC 186. In this case, UE 118 may detect that it is attached to a foreign network and is roaming, and thus, that a full SMS communication path is not available. Nevertheless, a user of UE 118 may input an SMS message via a native SMS messaging application of UE 118. In one example, the native SMS messaging application may be configured to pull text message content that is input via the native SMS messaging application and embed the text message content in a media file, e.g., a simple digital image, such as a JPEG file. In another example, a background service may have access to and may pull the text message content from the native SMS messaging application, and may embed the text message content in the digital image. The text message content may further include supplemental information that may comprise an identifier of UE 118, as the sender, and an identifier of UE 117, as the intended recipient, which may be embedded in the digital image as part of or along with the text message content. UE 118 may next establish a communication session with SMS mediator 148 via an over-the-top (OTT) messaging service in accordance with an OTT messaging application that is installed and in operation on UE 118, and may send the digital image (containing the embedded text message content) to the SMS mediator 148 via the communication session.

In one example, UE 118 may encrypt the text message content prior to embedding the text message content in the digital image. In another example, the text message content may be embedded in the digital image and the digital image may be encrypted as a whole, e.g., using session keys for the session between UE 118 and SMS mediator 148. In one example, the digital image may be an actual image comprising visual content that is renderable via a display screen and discernable to a human viewer. For instance, one or more default images may be selected, e.g., randomly or otherwise, for use as containers for embedding and transporting the text message content. Alternatively, or in addition, a user of UE 118 may select an image, or may select a plurality of images from which UE 118 may choose an image for use in conveying the text message content to SMS mediator 148. In one example, the one or more images (e.g., one or more designated “SMS transport images”) may be known to the SMS mediator 148 in advance. Thus, as an added layer of security, SMS mediator 148 may compare the received digital image with digital image(s) associated with UE 118. If the image is not a match to any of the known/permitted digital image(s), the message may be rejected. However, in another example, the digital image may be padded with random data in addition to the text message content (e.g., since no image is actually rendered at SMS mediator 148, it may be of no consequence that a resultant image would comprise pixels of random colors, intensities, etc.).

It should again be noted that the OTT messaging application may be for real-time and/or non-real time based communications, e.g., a VoIP application, a video chat application, a non-SMS text-based messaging application, an image-based messaging application, and so forth. For instance, the over-the-top messaging application may include Skype™, Facetime™, Facebook Messenger™, Snapchat™, Instagram™, and so forth. However, in one example, each of these OTT messaging applications may permit the transmission of a media file as a primary medium of communication, or supplemental to a primary medium of communication. For instance, an application such as Snapchat™ or the like may utilize captioned digital images as a primary medium of communication. Thus, a digital image containing text message content may be conveyed via such a primary medium of communication. However, for a VoIP application, the primary medium of communication may be packets of voice/sound data. Nevertheless, a VoIP application may also enable the sending of media files, such as digital images, ancillary to a voice/sound-based communication session, and similarly for video chat applications, or the like.

The SMS mediator 148 may receive the digital image and may then extract the text message content, identify the intended recipient (UE 117), and may generate an SMS message for forwarding to UE 117. For instance, SMS mediator 148 may communicate with SMPP gateway 191 and/or HSS 109 to locate UE 117 and identify SMPP gateway 191 and/or SMS 190 as currently serving the UE 117. The SMPP gateway 191 and/or SMSC 190 may then forward the SMS message to UE 117 as any other SMS message. In one example, SMSC 190 may store the SMS message until the SMS message is deliverable to UE 117. UE 117 may then receive and present the SMS message via the native SMS application of UE 117. In one example, the SMS message may indicate UE 118 as the sender. In another example, the SMS message may indicate SMS mediator 148 as the sender and may include addition content in the SMS message, or in a second SMS message, to indicate UE 118 as the originator, such as “forwarded by SMS mediator for abc-xyz-1234,” or similar information.

It should be noted that the SMS mediator 148 and UE 118 may establish a communication session in a manner that is transparent to a user of UE 118. For example, the native SMS application or background service may access the OTT messaging application via an API that may allow the active use of the OTT messaging application but without engaging a display of the UE 118, without activating and accessing a camera and/or microphone of UE 118, and so forth. Alternatively, or in addition, the OTT messaging application may be opened/activated and closed/deactivated in fast succession in order to establish the session, send the digital image, and close the session, where an application window may appear in all or part of a display of UE 118 and may disappear upon ending the communication session and closing the application by the native SMS application or background service. It should also be noted that the digital image may include additional information to enable SMS mediator 148 to extract the text message content. For instance, a header field of the digital image (e.g., a media file) may be available for optional use and may be used to include a value that may identify where the text message content may be located within the digital image file, how the text message content may be encrypted (e.g., a selected steganography technique, any keys, codebooks or codebook entries utilized, etc.), and so forth.

To summarize, UE 118 may detects that UE 118 is foreign roaming and that a user wants to send an SMS message. UE 118 may detect an available OTT messaging app, convert text message content to an encoded digital image with destination/recipient information and content, and may use an API to access the OTT messaging application to send the digital image to SMS mediator 148. In turn, SMS mediator 148 may extract the text message content from the digital image, generate an SMS message, and forward the SMS message to the recipient UE 117 (e.g., via SMPP gateway 191 and/or SMSC 190). UE 117 may then use a native SMS application to receive and present the SMS message. In addition, a user of UE 117 may reply to the converted SMS message also using the native SMS application of UE 117, as described in further detail below.

In particular, a user of UE 117 may generate an SMS message via the native SMS application of UE 117. UE 117 may thus send the SMS message to SMSC 190, which may then query for where to forward the SMS message, e.g., from MME 107, HSS 109, and/or SMPP gateway 191. In particular, one of these entities may provide SMSC 190 with a reply indicating that the SMS message should be forwarded to SMS mediator 148 (or to SMPP gateway 191, which may be tasked with forwarding to SMS mediator 148). To illustrate, UE 118 may be foreign roaming and may have no access to SMSC 186 of a foreign telecommunication network. However, UE 118 may have a data connection via such telecommunication network and may be assigned an IP address. UE 118 may also periodically transmit this information to the home network of UE 118 (e.g., telecommunication service provider network 170). For instance, UE 118 may be configured to transmit assigned IP address information to HSS 109, SMS mediator 148, or another entity of telecommunication service provider network 170 when UE 118 is roaming.

In any case, SMS mediator 148 may be made aware and may store a record of the IP address of UE 118 (and in one example, a notation that UE 118 is without SMS service). Accordingly, SMS mediator 148 may receive the SMS message, extract the text message content, and embed such text message content in a media file (e.g., a digital picture or the like). In addition, SMS mediator 148 may attempt to establish a communication session with UE 118 via an OTT messaging application service. In one example, the OTT messaging application may not require a user to actively answer a call. Rather, the OTT messaging application may permit asynchronous messaging. In one example, the native SMS application of UE 118 and/or a background service with appropriate permissions may access the received message(s) of the OTT messaging application on UE 118. In particular, the UE 118, via the native SMS application and/or the background service may scan the received message(s) and may identify a sender as SMS mediator 148. For instance, the native SMS application and/or the background service may be provided with a list of one or more sources from which it is understood that a message does not include content that is intended for receipt by a user via the OTT messaging application, but instead comprises embedded text message content to be extracted and presented via the native SMS application of the UE 118. In such case, UE 118, via the native SMS application and/or the background service, may extract the text message content, may formulate an SMS message containing the text message content, and may provide the SMS message to the native SMS application via an API for presentation (or may present the SMS message via the native SMS application, in the case that these functions are part of the native SMS application itself). As in the previous example, the SMS message may indicate SMS mediator 148 as the source, with an identification of UE 117 as the originator. Alternatively, a separate message may be sent indicating the originator (e.g., two messages sent simultaneously or in fast succession), such as “Forwarded by SMS mediator on behalf of xyz-123-abcd,” or the like.

In still another example, a user of UE 116 may seek to access a website of a business, e.g., hosted via server(s) 189. In one example, the website may be configured to require a two-factor authentication process to be completed in order to allow such access. As illustrated in FIG. 1, UE 116 may at one time have been attached via cell site 111 of access network 103. However, at a current time UE 116 may be without cellular connectivity. For instance, UE 116 may have Wi-Fi network connectivity via other network(s) 180, with cellular service turned off/disabled. For example, the user of UE 116 may be at home or at a workplace with available Wi-Fi. Alternatively, a user of UE 116 may be in a foreign country and does not wish to enable cellular roaming. However, UE 116 may have network connectivity via hotel network (e.g., a local area network (LAN), which may comprise a wireless LAN (WLAN) and/or which may comprise a wired connection that is made available to UE 116, e.g., an Ethernet network, or the like).

In such case, UE 116 may be assigned a public IP address that may be communicated to the home network of UE 116, and which may thus be stored by or made available to SMS mediator 148 and/or SMPP gateway 191. Continuing with the present example, the website (e.g., server(s) 189) may initiate a two-factor authentication process by instructing ESME 185 to transmit an SMS message containing an authentication code the UE 116. In one example, the message may be communicated by ESME 185 to SMSC 186 (e.g., of another telecommunication network) or toward SMSC 190, SMPP gateway 191, and/or SMS mediator 148. In an example in which the SMS messages is received by SMSC 190, the SMSC 190 may query where to send the SMS message (e.g., from MME 107 and/or HSS 109), and may be directed to forward to the SMS message to SMPP gateway 191 and/or to SMS mediator 148 via SMPP gateway 191. In any case, the SMS message may be obtained by SMS mediator 148, which may then perform a lookup to identify how UE 116 is addressable (e.g., a current or last-known public IP address of UE 116). In addition, SMS mediator 148 may extract the text message content from the SMS message, and embed such text message content in a media file (e.g., a digital image, or the like). SMS mediator 148 may then establish a communication session with UE 116 in accordance with an OTT messaging application, and transmit the media file to UE 116 via the communication session, e.g., over other network(s) 180. The media file may be received by UE 116 via the OTT messaging application, and the text message content may be extracted and presented as an SMS message in accordance with a native SMS application of UE 116, similar to the example(s) above.

It should be noted that the foregoing are just several examples of alternate, OTT application delivery of SMS messages in accordance with the present disclosure, and that other, further, and different examples may alternatively or additionally be implemented via the system 100. In one example, SMS mediator 148 may include or comprise an IP short message service center (IP-SMSC). An IP-SMSC may provide for session initiation protocol (SIP)-based and/or SMPP-based forwarding of SMS messages for endpoint devices with data connections (e.g., those serviced by UTRAN or eUTRAN access network infrastructure and IP/packet-based core network infrastructure). Thus, as illustrated in FIG. 1 SMS mediator 148 may interface with PDN GW 110, and/or IMS network 115 to send and receive SMS messages of UEs attached via access network 103 using SIP or SMPP. In one example, an IP-SMSC may also communicate with SMPP gateway 191 via SMPP. For instance, SMS mediator 148 may function as an external short message entity (ESME) that may communicate with SMPP gateway 191 via SMPP. In one example, the SMPP gateway 191 may translate SMS messages received via SMPP for transmission to SMSC 190 via SS7, and may translate SMS messages received from SMSC 190 via SS7 into SMPP format for transmission to SMS mediator 148. As noted above, in another example, SMPP gateway 191 may function as a routing entity (RE) and simply convey SMS messages to SMSC 190 via SMPP, while the SMSC 190 translates the SMS message into SS7 format for delivery to an intended UE, or UEs.

In one example, SMS messages may be forwarded to and received from endpoint devices using SMS over SIP or SMS over SMPP via an IP/packet-based infrastructure as a preferred method of delivery, while SMS via SS7 over NSS/GSM core network components may be used if data network connections are not available. For example, SMS mediator 148 may comprise a master short message service center that is used for primary management of SMS messages in the telecommunications service provider network 170, while SMSC 180 may be used for endpoint devices that do not have data connections via UTRAN/GPRS, eUTRAN/LTE, and or 5G infrastructure. It should be noted, however, that the foregoing relates to how SMS mediator 148 may serve UEs that have SMS connectivity via cellular network 101, and that SMS mediator 148 may still further be configured to extract text message content from SMS messages, embed the text message content in media files, and transmit the media files to recipient devices via one or more OTT messaging applications as described above. For instance, SMS mediator 148 may receive media files containing embedded text message content from senders via one or more OTT messaging applications and/or may transmit media files containing embedded text message content to recipients, e.g., to and from UEs without cellular connectivity (e.g., “data only” connectivity), UEs roaming internationally, and/or UEs otherwise without SMS service.

In addition, it should be noted that the system 100 has been simplified. In other words, the system 100 may be implemented in a different form than that which is illustrated in FIG. 1. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, various elements of access network 103, EPC network 105, and IMS network 115 are omitted for clarity, including gateways or border elements providing connectivity between such networks, internal routers within EPC network 105, and so on. Similarly, due to the relatively large number of connections available between devices in the system 100, various links between MME 107, SGW 108, cell sites 111-113, SMSC 190, SMPP gateway 191, PDN GW 110, SMS mediator 145, and other components of system 100 are also omitted for clarity.

In addition, although aspects of the present disclosure have been discussed above in the context of a long term evolution (LTE)-based core network (e.g., EPC network 105), examples of the present disclosure are not so limited. For example, as illustrated in FIG. 1, the cellular network 101 may represent a “non-stand alone” (NSA) mode architecture where 5G radio access network components, such as a “new radio” (NR), “gNodeB” (or “gNB”), and so forth are supported by a 4G/LTE core network (e.g., a Evolved Packet Core (EPC) network 105). However, in another example, system 100 may instead comprise a 5G “standalone” (SA) mode point-to-point or service-based architecture where components and functions of EPC network 105 are replaced by a 5G core network, which may include an access and mobility management function (AMF), a user plane function (UPF), a session management function (SMF), a policy control function (PCF), a unified data management function (UDM), an authentication server function (AUSF), an application function (AF), a network repository function (NRF), and so on. In addition, any one or more of cell sites 111-113 may comprise 2G, 3G, 4G and/or LTE radios, e.g., in addition to 5G new radio (NR) functionality (or in accordance with any other future new radio standards). For instance, in non-standalone (NSA) mode architecture, LTE radio equipment may continue to be used for cell signaling and management communications, while user data may rely upon a 5G new radio (NR), including millimeter wave communications, for example.

Similarly, although the SMS mediator 148 is illustrated as a component of service network 140, and SMSC 190 and SMPP gateway 191 are illustrated as components within EPC network, in other examples, any one or more of these components may be deployed in a different configuration. For example, SMS mediator 148 may be deployed within IMS network 115, or within EPC network 105. In another example, SMSC 190 and SMPP gateway 191 may be combined into a single component within EPC network 105, within IMS network 115, or in service network 140. In still another example, SMS mediator 148 may communicate directly with SMSC 190 (e.g., without intervening SMPP gateway 191) using SMS messages encapsulated via SMPP or SIP. For instance, SMSC 190 may comprise or include an IP-SMSC. Thus, these and other modifications are all contemplated within the scope of the present disclosure.

FIG. 2 illustrates a flowchart of an example method 200 for transmitting a media file having an embedded text message content via an over-the-top messaging application to a network-based short message service mediation server for forwarding the text message content to a recipient via a short messaging service message, in accordance with the present disclosure. In one example, steps, functions and/or operations of the method 200 may be performed by an endpoint device, or user equipment, such as one of UEs 116-118 of FIG. 1 (e.g., a “mobile communication device”). In one example, the steps, functions, or operations of method 200 may be performed by a computing device or system 500, and/or processor 502 as described in connection with FIG. 5 below. For instance, computing device or system 500 may represent a mobile communication device (UE/endpoint device) of the present disclosure. For illustrative purposes, the method 200 is described in greater detail below in connection with an example performed by a processing system. The method 200 begins in step 205 proceeds to step 210.

At step 210, the processing system (e.g., of a mobile communication device) obtains a text message content and an identification of a recipient (e.g., at least one recipient) via a native SMS application of the mobile communication device (e.g., an SMS application that is integrated with an operating system of the mobile communication device and/or a default SMS application). For instance, step 210 may comprise obtaining a user input of the text message content via the native SMS application.

At optional step 220, the processing system may detect that a connection to an SMS server (e.g., an SMSC) is unavailable. For instance, in one example, an SMS server may be detected to be unavailable when the mobile communication device is attached to an access network that is not associated with a home network of the mobile communication device (e.g., when the mobile communication device is roaming internationally, or the like). In one example, an SMS server may be detected to be unavailable when the mobile communication device obtains a user input indicating to not connect to SMS servers. Alternatively, or in addition, an SMS server may be detected to be unavailable when the mobile communication device is not attached to a cellular access network (e.g., when the mobile communication device has “Wi-Fi only” network connectivity, wired network connectivity, etc.). In still another example, SMS servers may be temporarily unavailable due to cellular access network and/or cellular core network issues, such as outages, maintenance, denial of service attacks, or other issues.

At optional step 230, the processing system may select a type of media file from among a plurality of media file types for embedding the text message content. For instance, the media file type may comprise a picture file type (e.g., digital images), a video file type, an audio file type, a document file type, etc. In one example, the selecting may be in accordance with a user input (e.g., indicating the preferred media file type). In another example, the selecting may be in accordance with a selection logic comprising a weighted random selection from among the plurality of media file types, a round-robin selection from among the plurality of media file types, or the like.

At step 240, the processing system embeds the text message content in a media file. For instance, the media file may be of a media file type that may be selected at optional step 230. In one example, the text message content may be embedded in a header portion of the media file. In another example, the text message content may be embedded in a content portion of the media file (e.g., using a steganography technique). In one example, the steganography technique may be selected from among a plurality of steganography techniques such as least significant bit encoding, pixel value differencing, edges based data embedding, random pixel embedding, discrete Fourier transform encoding, discrete cosine transform encoding, and so forth. In addition, in one example, the selecting may be in accordance with a selection logic comprising a weighted random selection from among the plurality of steganography techniques, a round-robin selection from among the plurality of steganography techniques, or the like. In one example, a selected steganography technique may be indicated by one or more values in one or more header fields of the media file (and the text message content may be embedded in the payload portion of the media file using the selected steganography technique). In one example, step 240 may further include embedding additional information, such as destination/recipient information in the media file (e.g., an IMSI or the like of the mobile communication device, as sender, an IMSI or the like of an intended recipient (or IMSIs of multiple intended recipients), etc). In one example, the additional information may be considered part of the text message content (e.g., in addition to any user-generated text). In another example, the additional information may be considered ancillary data that is embedded in the media file (e.g., at the same time or separately from the text message content), in either one or more header fields and/or in the payload of the media file.

At optional step 250, the processing system may select an over-the-top (OTT) messaging application from among a plurality of OTT messaging applications. The OTT messaging application may be a third-party messaging application that communicates via the Internet in general (e.g., over TCP/IP, UDP/IP, or the like), in contrast to the native SMS application integrated with the OS of the mobile communication device. In particular, the OTT messaging application may not interact with SMS servers of a telecommunication network service provider (and/or otherwise bypasses telecommunication network service provider infrastructure, e.g., where the telecommunication network service provider infrastructure is a mere conduit to transmit and/receive packetized data for the mobile communication device). For instance, examples of OTT messaging applications include Skype™, WhatsApp™, Facebook Messenger™, Blackberry Messenger (BBM)™, Facetime™, and so forth. In one example, a dedicated/default SMS application (e.g., a native SMS application) may also transmit SMS messages to and receive SMS messages from cellular access network infrastructure via one or more designated and/or reserved channels for SMS messages (e.g., which may be separate from data channels that are used for CDMA and OFDMA communications of UTRAN and eUTRAN-based components, and similarly with respect to general data communications via 5G NR). In one example, the OTT messaging application may be selected in accordance with a user input (e.g., indicating a preferred OTT messaging application). In another example, the selecting may be in accordance with a selection logic comprising a weighted random selection from among a plurality of OTT messaging applications, a round-robin selection from among a plurality of OTT messaging applications, or the like.

At step 260, the processing system transmits the media file via the OTT messaging application to a network-based SMS mediation server. For instance, the network-based SMS mediation server may be addressable via a designated identifier in accordance with the OTT messaging application (e.g., an IMSI number may be assigned to the SMS mediation server, the SMS mediation server may be assigned a username associated with the OTT messaging application, etc.). In one example, different SMS mediation servers may be available, from among which the processing system may select a closest SMS mediation server, an SMS mediation server that the mobile communication device has been previously instructed to utilize, etc. In one example, the embedding of step 240 and the transmitting of step 260 (as well as intermediate optional steps) may be performed in response to the detecting that an SMS server in unavailable at optional step 220.

The network-based SMS mediation server may be configured to extract the text message content from the media file and to transmit/forward the text message content to the recipient via an SMS message. In addition, the SMS mediation server may extract an identifier of the intended recipient(s) from the media file as part of or in association with the text message content. In one example, the mobile communication device and the SMS mediation server (or “SMS mediator”) may be configured to implement one or more steganography techniques, and any necessary keys, codebooks, or the like may be known and or shared in advance between the mobile communication device and the SMS mediation server, or via another entity in communication with both the mobile communication device and the SMS mediation server. In one example, the SMS mediation server may transmit the SMS message to one or more other SMS servers, such as an SMSC, an SMPP gateway, or the like, for onward forwarding/transmission to the intended recipient(s).

Following step 260, the method 200 proceeds to step 295 where the method 200 ends.

It should be noted that the method 200 may be expanded to include additional steps, may be modified to perform different steps, or may omit certain steps. For instance, in one example the processor may repeat various steps of the method 200 for sending additional text message content entered by a user via a native SMS application. In additional examples, the method 200 may further include obtaining a user input selecting the type of the media file and/or obtaining a user input selecting the over-the-top messaging application. In one example, the method 200 may be expanded or modified to include steps, functions, and/or operations, or other features described in connection with the example(s) of FIGS. 1, 3, and/or 4, or as described elsewhere herein. Thus, these and other modifications are all contemplated within the scope of the present disclosure.

FIG. 3 illustrates a flowchart of an example method 300 for extracting a text message content and an identification of a recipient from a media file received via an over-the-top messaging application message and transmitting the text message content to the recipient via a short messaging service message, in accordance with the present disclosure. In one example, steps, functions and/or operations of the method 300 may be performed by a network-based device, such as SMS mediator 148, or SMS mediator 148 in conjunction with other components of the system 100, such as SMSC 190, SMPP gateway 191, and so forth. In one example, the steps, functions, or operations of method 300 may be performed by a computing device or system 500, and/or processor 502 as described in connection with FIG. 5 below. For instance, computing device or system 500 may represent a SMS mediator (or “SMS mediation server”) of the present disclosure. For illustrative purposes, the method 300 is described in greater detail below in connection with an example performed by a processing system. The method begins in step 305 and proceeds to step 310.

At step 310, the processing system (e.g., of an SMS mediation server) obtains an over-the-top (OTT) messaging application message including a media file from a source mobile communication device, where the media file includes a text message content and an identification of a recipient that are embedded in the media file. For instance, the OTT messaging application message may be sent by the source mobile communication device and received by the processing system at step 310.

At step 320, the processing system extracts the text message content and the identification of the recipient from the media file. For instance, the text message content may be embedded in a content portion of the media file (e.g., using a steganography technique). In one example, the steganography technique may be selected from among a plurality of steganography techniques such as noted above. In one example, a selected steganography technique may be indicated in a header of the media file (and the text message content may be embedded in the payload portion of the media file using the selected steganography technique). Accordingly, in one example, the mobile communication device and the SMS mediation server (or “SMS mediator”) may be configured to implement one or more steganography techniques, and any necessary keys, codebooks, or the like may be known and or shared in advance between the mobile communication device and the SMS mediation server, or via another entity in communication with both the mobile communication device and the SMS mediation server.

In the event that multiple steganography techniques are available, the processing system may examine a relevant header field of the media file to identify which technique has been used in the present instance. In addition, the processing system may also obtain additional information from one or more relevant header fields, such as information indicating where in the body of the media file the text message content may be located (e.g., in the case in which the text message content may simply be appended or inserted into the body of the payload of the media file (e.g., in-block), and/or where a first portion of the text message content may be located (e.g., a pointer to a starting bit, a starting pixel, or the like for decoding the text message content that has been embedded via a steganography technique)). In addition, it should be noted that the identification of the recipient may comprise an IMSI (e.g., a telephone number), or the like that may be embedded as part of the text message content or separately, in association with the text message content.

At step 330, the processing system transmits the text message content to the recipient via an SMS message. For instance, step 330 may comprise formulating the SMS message, wherein the body/text of the SMS message may comprise the text message content that is extracted at step 320, a recipient field may be filled with the IMSI of the intended recipient, etc. In addition, step 330 may include transmitting/forwarding the SMS message to one or more other SMS servers, such as an SMSC, an SMPP gateway, or the like. In other words, the SMS message is transmitted from the processing system to the intended recipient via existing SMS infrastructure (e.g., in accordance with SMPP, SS7, etc.). In addition, the SMS message may be addressed in accordance with the identification of the recipient that may be extracted at step 320.

Following step 330, the method 300 proceeds to step 395 where the method 300 ends.

It should be noted that the method 300 may be expanded to include additional steps, may be modified to perform different steps, or may omit certain steps. For instance, in one example the processor may repeat various steps of the method 300 for additional text message content received from a mobile communication device for transmission to one or more intended recipients via SMS messages. In one example, the method 300 may further include storing the SMS message. For instance, in one example, the processing system may comprise or may be integrated with an SMSC. Thus, in the event that an intended recipient is presently not attached to the cellular network, or the SMS message is not presently deliverable, the processing system may temporarily store the SMS message until such time as the SMS message may be delivered. In one example, the method 300 may be expanded or modified to include steps, functions, and/or operations, or other features described in connection with the example(s) of FIGS. 1, 2, and/or 4, or as described elsewhere herein. Thus, these and other modifications are all contemplated within the scope of the present disclosure.

FIG. 4 illustrates a flowchart of an example method 400 for extracting a text message content from a media file received via an over-the-top messaging application message and presenting the text message content via a native short messaging service application of a mobile communication device, in accordance with the present disclosure. In one example, steps, functions and/or operations of the method 400 may be performed by an endpoint device, or user equipment, such as one of UEs 116-118 of FIG. 1 (e.g., a “mobile communication device”). In one example, the steps, functions, or operations of method 400 may be performed by a computing device or system 500, and/or processor 502 as described in connection with FIG. 5 below. For instance, computing device or system 500 may represent a UE/endpoint device of the present disclosure. For illustrative purposes, the method 400 is described in greater detail below in connection with an example performed by a processing system. The method 400 begins in step 405 proceeds to step 410.

At step 410, the processing system obtains an over-the-top (OTT) messaging application message including a media file from a network-based SMS mediation server, wherein the media file comprises a text message content that is embedded in the media file.

At step 420, the processing system extracts the text message content from the media file. For instance, step 420 may be the same or similar to step 320 of the example method 300 discussed above (however, in the present example, the operations are performed by a processing system of a mobile communication device). In this regard, it should be noted that the mobile communication device (e.g., the processing system thereof) and the SMS mediation server may be configured to implement one or more steganography techniques, and any necessary keys, codebooks, or the like may be known and/or shared in advance between the mobile communication device and the SMS mediation server, or via another entity in communication with both the mobile communication device and the SMS mediation server. Thus, in one example, step 420 may include determining a selected steganography technique, which may be indicated in a header of the media file (and the text message content may be embedded in the payload portion of the media file using the selected steganography technique). Step 420 may alternatively or additionally include identifying a pointer that indicates where to locate the text message content within the body/payload of the media file, extracting an identifier of the source of the text message content (e.g., the sender, rather than the SMS mediation server as an intermediary), and so forth.

At step 430, the processing system presents the text message content via a native SMS application of the mobile communication device. For instance, in one example the processing system may formulate an SMS message and pass the SMS message to the native SMS application via an API for local interworking between a background service via which the method 400 is implemented and the native SMS application. In another example, the native SMS application may include additional functionality in accordance with the example method 400, and thus may directly present the text message content and sender information, similar to as if the information were received via an SMS message.

Following step 430, the method 400 proceeds to step 495 where the method 400 ends.

It should be noted that the method 400 may be expanded to include additional steps, may be modified to perform different steps, or may omit certain steps. For instance, in one example the processor may repeat various steps of the method 400 for additional text message content received via OTT messaging application messages. In one example, the method 400 may further include communicating an IP address of the mobile communication device to the SMS mediation server, such that the SMS mediation server may address the OTT messaging application message to the mobile communication device. In one example, the method 400 may include detecting that a connection to an SMS server (e.g., an SMSC) is unavailable. In addition, in one example, the method 400 may further include selecting an OTT messaging application and communicating the selection of the OTT messaging application message to the SMS mediation server (e.g., in response to detecting that a connection to an SMS server is unavailable). Similarly, in one example, the method 400 may further include selecting a steganography technique from among a plurality of steganography techniques, and communicating the selected steganography technique to the SMS mediation server (which may also include communicating keys, codebook entries, or the like for the SMS mediation server to use in connection with the embedding of the text message content in the OTT messaging application message, e.g., also in response to detecting that a connection to an SMS server is unavailable). In one example, the method 400 may be expanded or modified to include steps, functions, and/or operations, or other features described in connection with the example(s) of FIGS. 1, 2, and/or 3, or as described elsewhere herein. Thus, these and other modifications are all contemplated within the scope of the present disclosure.

In addition, it should be noted that although not specifically specified, one or more steps, functions or operations of the example methods 200, 300, and/or 400 may include a storing, displaying and/or outputting step as required for a particular application. In other words, any data, records, fields, and/or intermediate results discussed in the method(s) can be stored, displayed and/or outputted to another device as required for a particular application. Furthermore, steps or blocks in FIGS. 2-4 that recite a determining operation or involve a decision do not necessarily require that both branches of the determining operation be practiced. In other words, one of the branches of the determining operation can be deemed as an optional step. In addition, one or more steps, blocks, functions, or operations of the above described method(s) may comprise optional steps, or can be combined, separated, and/or performed in a different order from that described above, without departing from the example embodiments of the present disclosure.

FIG. 5 depicts a high-level block diagram of a computing device specifically programmed to perform the functions described herein. As depicted in FIG. 5, the system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for transmitting a media file having an embedded text message content via an over-the-top messaging application to a network-based short message service mediation server for forwarding the text message content to a recipient via a short messaging service message, for extracting a text message content and an identification of a recipient from a media file received via an over-the-top messaging application message and transmitting the text message content to the recipient via a short messaging service message, and/or for extracting a text message content from a media file received via an over-the-top messaging application message and presenting the text message content via a native short messaging service application of a mobile communication device, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the example method(s) as discussed above is/are implemented in a distributed or parallel manner for a particular illustrative example, i.e., the steps of an above method, or the entire method is implemented across multiple or parallel computing device, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one embodiment, instructions and data for the present module or process 505 for transmitting a media file having an embedded text message content via an over-the-top messaging application to a network-based short message service mediation server for forwarding the text message content to a recipient via a short messaging service message, for extracting a text message content and an identification of a recipient from a media file received via an over-the-top messaging application message and transmitting the text message content to the recipient via a short messaging service message, and/or for extracting a text message content from a media file received via an over-the-top messaging application message and presenting the text message content via a native short messaging service application of a mobile communication device (e.g., a software program comprising computer-executable instructions) can be loaded into memory 504 and executed by hardware processor element 502 to implement the steps, functions or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for transmitting a media file having an embedded text message content via an over-the-top messaging application to a network-based short message service mediation server for forwarding the text message content to a recipient via a short messaging service message, for extracting a text message content and an identification of a recipient from a media file received via an over-the-top messaging application message and transmitting the text message content to the recipient via a short messaging service message, and/or for extracting a text message content from a media file received via an over-the-top messaging application message and presenting the text message content via a native short messaging service application of a mobile communication device (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

1. A method comprising:
obtaining, by a processing system of a mobile communication device, a text message content and an identification of a recipient via a native short message service application of the mobile communication device;
embedding, by the processing system, the text message content in a media file, wherein the media file comprises at least one of: a picture file, a video file, an audio file, or a document file; and
transmitting, by the processing system, the media file via an over-the-top messaging application to a network-based short message service mediation server, wherein the network-based short message service mediation server is to extract the text message content from the media file and to forward the text message content to the recipient via a short messaging service message.

2. The method of claim 1, further comprising:
detecting that a connection to a short message service server is unavailable, wherein the embedding and the transmitting are performed in response to the detecting that the short message service server in unavailable.

3. The method of claim 2, wherein the short message service server is detected to be unavailable when the mobile communication device is attached to an access network that is not associated with a home network of the mobile communication device.

4. The method of claim 2, wherein the short message service server is detected to be unavailable when the mobile communication device obtains a user input indicating to not connect to any short message service server.

5. The method of claim 2, wherein the short message service server is detected to be unavailable when the mobile communication device is not attached to a cellular access network.

6. (canceled)

7. The method of claim 1, further comprising:
selecting the over-the-top messaging application from among a plurality of over-the-top messaging applications.

8. The method of claim 1, further comprising:
selecting a type of the media file from among a plurality of media file types.

9. A method comprising:
obtaining, by a processing system deployed in a communication network, an over-the-top messaging application message including a media file from a source mobile communication device, wherein the media file comprises a text message content and an identification of a recipient that are embedded in the media file, wherein the media file comprises at least one of: a picture file, a video file, an audio file, or a document file;
extracting, by the processing system, the text message content and the identification of the recipient from the media file; and
transmitting, by the processing system, the text message content to the recipient via a short messaging service message.

10. The method of claim 9, wherein the processing system comprises a network-based short message service mediation server.

11. The method of claim 9, wherein the text message content is embedded in a content portion of the media file in accordance with a steganography technique.

12. The method of claim 11, wherein the extracting is in accordance with the steganography technique.

13. The method of claim 11, further comprising:
identifying the steganography technique, from among a plurality of steganography techniques, in accordance with a value indicated in a header of the media file.

14. (canceled)

15. A method comprising:
obtaining, by a processing system of a mobile communication device, an over-the-top messaging application message including a media file from a network-based short message service mediation server, wherein the media file comprises a text message content that is embedded in the media file, wherein the media file comprises at least one of: a picture file, a video file, an audio file, or a document file;
extracting the text message content from the media file; and
presenting the text message content via a native short messaging service application of the mobile communication device.

16. The method of claim 15, wherein the over-the-top messaging application message includes an identification of the network-based short message service mediation server as a sender, and wherein the extracting is performed in response to the identification of the network-based short message service mediation server as a sender.

17. The method of claim 15, further comprising:
detecting that a connection to a short message service server is unavailable.

18. The method of claim 17, further comprising:
selecting the over-the-top messaging application from among a plurality of over-the-top messaging applications; and
notifying the network-based short message service mediation server of the over-the-top messaging application that is selected.

19. The method of claim 17, further comprising:
selecting a type of the media file from among a plurality of media file types; and
notifying the network-based short message service mediation server of the type of the media file that is selected.

20. (canceled)

21. The method of claim 15, wherein the text message content is embedded in a content portion of the media file in accordance with a steganography technique.

22. The method of claim 21, wherein the extracting is in accordance with the steganography technique.

23. The method of claim 21, further comprising:
identifying the steganography technique, from among a plurality of steganography techniques, in accordance with a value indicated in a header of the media file.
